(19) United States
(12) Patent Application Publication
(10) Pub. No.: US 2008/0201877 A1
(43) Pub. Date: Aug. 28, 2008

(54) Hand-held cleaning/polishing machine

(75) Inventors: Frank Sengewald, Beilstein (DE); Bernd Augustin, Pleidelsheim (DE)

Correspondence Address: Lipsitz & McAllister, LLC, 755 MAIN STREET, MONROE, CT, 06468, US

(73) Assignee: Flex-Elektrowerkzeuge GmbH, Steinheim/Murr (DE)

(21) Appl. No.: 11/986,666

(22) Filed: Nov. 21, 2007

(30) Foreign Application Priority Data
Feb. 22, 2007 (DE) 10 2007 010 303.6
Sep. 21, 2007 (EP) 07 116 935.3

(51) Int. Cl. A47L 11/00; B08B 3/00; B24B 7/18; B24B 23/02; B24B 57/02; A47L 11/282; A47L 11/14

(52) U.S. Cl. 15/4; 15/98; 15/50.1; 15/29; 451/354; 451/353; 451/344

(57) ABSTRACT

In order to provide a hand-held cleaning/polishing machine, comprising a holding device for holding the cleaning/polishing machine, a drive motor, a tool head for one or more cleaning tools and/or polishing tools, which has a tool drive shaft driven by the drive motor, and a transmission device for transmitting torque from the drive motor to the tool drive shaft, which is universally usable, it is provided that at least one coupling for connecting at least one first fluid line is arranged on the holding device and that at least one second fluid line leads to the tool head from the at least one coupling.

The present disclosure relates to the subject matter disclosed in German application number 10 2007 010 303.6 of Feb. 22, 2007 and European application number EP 07 116 935.3 of Sep. 21, 2007, which are incorporated herein by reference in their entirety and for all purposes.

### BACKGROUND OF THE INVENTION

The invention relates to a hand-held cleaning/polishing machine, comprising a holding device for holding the cleaning/polishing machine, a drive motor, a tool head for one or more cleaning tools and/or polishing tools, which has a tool drive shaft driven by the drive motor, and a transmission device for transmitting torque from the drive motor to the tool drive shaft.

Cleaning/polishing machines of this type are used for treating surfaces. With a polishing machine, surfaces can be polished and/or smoothed and/or rubbed and/or sanded and/or buffed and/or abraded and/or grinded.

A motor-driven sanding apparatus is known from EP 0 727 281 B1, which comprises a drive motor attached to a distal end of a tubular rod and a flexible drive shaft actively coupled to the drive motor and extending along the length of the tubular rod. A sanding shoe is actively coupled to the flexible drive shaft, the shaft ensuring the active coupling in different positions of the head with respect to the tubular rod.

A sanding machine is known from U.S. Pat. No. 5,239,783 A, in which a drive motor is coupled to a flexible shaft, which is guided in a flexible cover.

A hand-held sanding machine is known from U.S. Pat. No. 4,782,632 A, in which the motor is coupled to a shaft and a tool is coupled to a shaft, the two shafts being coupled by means of a flexible spring drive.

A sanding machine for treating floors is known from DE 81 00 197.5 U1, which has a sanding plate driven by an electric motor and covered with sandpaper. A guide rod which is suitable for a standing operator to handle the sanding machine is arranged on the motor housing of the electric motor.

An electric hand tool is known from DE 100 01 091 A1, in which a tool receiver is coupled by means of a spindle to a drive shaft in a gearing housing, the gearing housing being configured in two parts and the two parts of the gearing housing being rotatable relative to one another in a rotational plane extending inclinedly to the drive shaft and the spindle and being lockable in the respectively desired rotational position.

Further hand-held sanding machines are known from U.S. Pat. No. 4,685,252 A, U.S. Pat. No. 4,974,371 A and U.S. Pat. No. 1,134,116.

A cleaning apparatus for cleaning the outer skin of aircraft and land vehicles or the hulls of boats, which has a cleaning head, which is arranged at the free end of an elongated, tubular shaft, is known from EP 1 066 122 B1. The cleaning head comprises a cleaning tool which can be driven in a rotating or oscillating manner by an electric motor. The electric motor is arranged inside a handle section, which is arranged remote from the cleaning head, with handles for guiding the cleaning apparatus and is drive-coupled to the cleaning tool by means of a flexible shaft. The cleaning head is configured so as to be pivotable about an axis extending transversely to the central longitudinal axis of the cleaning apparatus and intersecting this longitudinal axis, a locking device being provided, by means of which the cleaning head car be releasably locked in defined orientations with regard to a longitudinal central plane of the shaft containing the central axis of the shaft and the axis. A spray device is provided, with which a cleaning fluid can be sprayed into a working region. The fluid is supplied to spray nozzles by means of a supply tube rigidly laid along the shaft, which tube is connected in a handle section to a flexible supply line which leads to a supply container.

A cleaning machine is known from WO 99/05955 A1, in which a fluid reservoir with a pump is arranged on a shaft. Fluid is supplied by means of a fluid line from the fluid reservoir to the treatment tools.

### SUMMARY OF THE INVENTION

In accordance with the invention, a hand-held cleaning/polishing machine is provided, which is universally usable.

In accordance with an embodiment of the invention, in the hand-held cleaning/polishing machine at least one coupling for the connection of at least one first fluid line is arranged on the holding device and at least one second fluid line leads to the tool head from the at least one coupling.

This makes it possible to connect an external fluid source such as a water tap by means of a hose, for example, as the first fluid line to the cleaning/polishing machine according to the invention and/or to connect, for example, an “internal” fluid source, such as a fluid container arranged on the cleaning/polishing machine. An operator can therefore resort to a water pipeline network when the water consumption is high and a water pipeline network is available. If the water pipeline network is not available, fluid can be provided from the internal fluid source.

The fluid may, for example, be cleaning fluid or polishing fluid.

The hand-held cleaning/polishing machine can be used, for example, only as a cleaning machine if a corresponding cleaning tool, such as, for example an oscillating or rotating rotary brush is used. Use only as a polishing machine (for polishing, sanding . . . ) is also possible if a polishing disc (sanding disc) is used as a polishing tool (or buffing tool).

It may also be provided that the cleaning/polishing machine contains the cleaning treatment and the polishing treatment as adjustable options, for example, by adjusting the rotational speed of the drive motor.

According to the invention, a cleaning/polishing machine is provided, which can easily be adapted to the treatment to be carried out.

The drive motor is an electric motor, for example, which is operated by mains power or else by means of a storage battery. However, it is basically also possible, for the drive motor to be a combustion motor.

It is favourable if (at least) one fluid container is arranged on the holding device. An internal source for fluid, such as, for example, cleaning fluid or polishing fluid can thus be provided. Thus, fluid can be provided for the tool even if no access to an external source is possible.

A fluid line is favourably arranged on the fluid container and can be connected to the at least one coupling. This fluid line, in particular, forms the first fluid line. An operator can decide whether to connect this fluid line, which is connected to the fluid container, to the coupling or, for example, to an external source. It is also possible for fluid to be supplied from the fluid container as the internal source and also from an external source to a tool of the cleaning/polishing machine. For example, water is supplied from the external source and a liquid cleaning agent is supplied from the fluid container.

It is particularly favourable if an external hose and/or the fluid line connected to the fluid container can selectively be connected fluidically to the second fluid line by the at least one coupling. Thus, an operator can select where the fluid for the cleaning process or polishing process should come from.

In particular, the fluid container is configured as a pressure container. Thus, the fluid can easily be conveyed from the fluid container to the tool head.

In particular, a pump is arranged on the fluid container in order to be able to place the fluid in the fluid container under pressure and to thereby allow conveyance of the fluid to the tool head in any position of the cleaning/polishing machine.

It is basically possible for the pump to be an electric pump, for example. In a structurally simple embodiment, the pump is a hand pump. An operator can fill the fluid container and then produce pressure by means of the hand pump.

It is particularly advantageous if the fluid container or a part of the fluid container can be removably fixed to the holding device. This means that filling is possible in a simple manner. The fluid container can be removed and filled and then fixed again to the holding device.

A suction line is favourably arranged in the fluid container and is connected in a fluid-active manner to the fluid line connected to the fluid container. Fluid can be sucked from the fluid container by means of the suction line and supplied to the tool head.

It is quite particularly advantageous if the suction line is flexible. It can then adopt a position with the fluid container, depending on the position of the fluid container, relative to the direction of gravitational force, which is on or close to a lower region of the liquid volume in relation to the direction of gravitational force. This suction line can automatically adopt the corresponding position owing to the flexible configuration. This ensures that fluid can be conveyed from the fluid container in any position of the cleaning/polishing machine. For example, a conveyance of fluid is also therefore possible if work is carried out overhead.

It is favourable if a weight element is arranged at or close to an inlet of the suction line. The weight element ensures the corresponding gravitational force orientation of the suction line.

It is quite particularly advantageous if a handle is arranged on the holding device between an end adjacent to the tool head and an end remote from the tool head. The holding device has a handle section, on which this handle is arranged. The hand-held cleaning/polishing machine can be held and guided by means of the latter.

The handle is advantageously configured as a bow-shaped handle. This allows a secure grip and pushing and pulling forces may also be exerted on the tool head.

It is quite particularly advantageous if a position of the handle on the holding device is variably adjustable. As a result, an operator can adapt the holding position to his body size and/or to the special treatment process. For example, an adaptation is thereby possible if a floor treatment, a wall treatment or a ceiling treatment is to be carried out.

In particular, the handle is arranged on a fixing device.

It is favourable if the fixing device can be displaceably positioned on the holding device so as to be lockable. For example, the fixing device is configured as a clamping holder. By clamping the clamping holder on the holding device, the position of the handle is fixed.

Advantageously, a spacing of the handle from the at least one coupling can be adjusted to allow a variable adaptation.

For the same reason, it is favourable if a spacing of the handle from a fixing device of the tool head on the holding device can be adjusted. Thus, the spacing of the holding position of the operator from the tool head can be adjusted, in particular.

In particular, a fluid container is arranged on the fixing device of the handle. Owing to the fixing device for the handle, a device is provided, on which the fluid container can easily be arranged. The hand-held cleaning/polishing machine can thus be configured in a simple manner.

The fluid container is preferably displaceably positioned on the holding device so as to be lockable with the fixing device of the handle. This produces a simple design structure of the hand-held cleaning/polishing machine according to the invention. It is in particular ensured that the adjustability of the position of the handle is not impeded by the fluid container.

A spacing of the fluid container from the at least one coupling is also variable owing to the displaceability of the fixing device on the holding device. It is accordingly favourable if a fluid line, which leads from the fluid container to the at least one coupling for connection thereto, is configured so as to be flexible in such a way that it allows the spacing variation.

In an embodiment which is simple in terms of manufacturing, the fixing device of the holding device comprises a clamping holder for fixing on the holding device.

In particular, the handle is positioned between the drive motor and the at least one coupling, i.e. positioned in a central handle section of the cleaning/polishing machine.

It is furthermore favourable, if a handle is provided, which is arranged on or close to an end of the holding device adjacent to the tool head. A further handle section is thus formed, on which a user can hold the hand-held cleaning/polishing machine. Further adaptation to the special treatment conditions and also to the body size of an operator is thus made possible.

In particular, the handle is configured as a bow-shaped handle or spherical handle to allow secure holding and, for example, so as to be able to exert pulling forces or pushing forces.

It is advantageous if a spacing of the handle from the at least one coupling can be adjusted. This produces universal use possibilities. Furthermore, treatment is facilitated if a corresponding adjustability is possible.

Favourably, it is possible to adjust a spacing of the handle relative to a fixing device of the tool head on the holding device.

It is provided that the at least one coupling is positioned between the handle and a further handle, which is arranged on the holding device. The further handle forms a first handle section and the other handle forms a second handle section. In one embodiment, the handle is held on a second element of the holding device, which is at least partly inserted into a receiving space of a first element of the holding device. The position of this handle on the holding device can thus be easily adjusted.

In an embodiment which is simple in terms of manufacturing, the second element is a rod.

It is also favourable if the first element is a tube. The corresponding holding device can then be produced in a simple manner.

It may also be provided that the at least one coupling is arranged on the first element and fixed there.

It is furthermore favourable if a handle is provided, which is arranged on or close to an end of the cleaning/polishing machine remote from the tool head. An operator can thus hold the hand-held cleaning/polishing machine on or close to the upper end. For example, the cleaning/polishing machine can be held in this region in the manner of a tool handle (such as a broom handle or shovel handle).

In one embodiment, the handle has a hand plate. This allows a secure grip to be achieved.

It is favourable if the handle is configured as a cylindrical handle.

It is also possible for the handle to project beyond the drive motor. Holding in this region is thus not impeded by the drive motor.

In an alternative embodiment, the handle is formed on a motor housing of the drive motor, i.e. this motor housing itself acts as the handle.

It may be provided here that the handle, which is arranged on or close to the end of the cleaning/polishing machine remote from the tool, can be removed. This allows, for example, the length dimensions of the cleaning/polishing machine to be reduced for transportation and storage.

It is quite particularly advantageous if the drive motor is arranged on the holding device and is, in particular, arranged in an upper end region of the holding device. This allows the transmission device for transmitting torque from the drive motor to the tool head to be configured in a simple manner. Furthermore, a counterweight to the tool head can be provided by means of the drive motor to facilitate the operability. Furthermore, the cleaning/polishing machine can be configured so as to be compact.

It is basically possible here for the drive motor to be removable and, in particular, to be configured in conjunction with a corresponding motor housing in such a way that a treatment tool, such as, for example, a polishing disc can be positioned on the motor housing. A universally usable machine is thus provided.

In particular, the drive motor is arranged on the holding device on or close to an end remote from the tool head. This facilitates the operability as, for example, the drive motor has to be raised by a lesser height when treating a wall.

It is quite particularly advantageous if the drive motor has an adjustable rotational speed to allow optimised adaptation to a machining process and universal use.

It is particularly advantageous if the drive motor has at least a first rotational gear for cleaning processes and a second rotational gear for polishing processes. Generally, a higher rotational speed is necessary for polishing processes than for cleaning processes or cleaning processes should not be carried out with too high a rotational speed so as to prevent damage to the surface being cleaned.

For example, a rotational tool speed is provided for the first rotational gear, which is below 2,000 revolutions per minute. The rotational speed of the drive motor may differ here from the rotational tool speed, as, for example, the torque transmission device comprises a rotational speed gear reduction.

It may also be provided that a rotational tool speed for the second rotational gear is a rotational speed above 2,000 revolutions per minute. For example, a rotational tool speed for the first rotational gear is about 1,000 revolutions per minute and, for the second rotational gear is about 3,000 revolutions per minute.

Advantageously, the tool head is arranged with a fixing device on the holding device so as to be pivotable about at least one pivot axis. Thus, for example, it is possible to easily treat a wall or floor as the angle between the holding device and the treatment face is adjustable.

In an advantageous embodiment, the at least one pivot axis is oriented transverse to a longitudinal direction of the holding device. Thus, the angular position of a treatment face of the treatment tool can be adjusted relative to the longitudinal axis of the holding device.

In a structurally simple embodiment, the fixing device for the tool head comprises a holding fork member. A pivot bearing for the pivotable bearing arrangement of the tool head on the holding device can be easily implemented by means of a holding fork member.

It is favourable if the fixing device for the tool head comprises a curved element, which is positioned on the holding device. The tool head can be positioned spaced apart from the holding device by means of the curved element, so a pivotability of the tool head is not impeded by the holding device.

Advantageously, the second fluid line is guided at least partly in the curved element. At least one part region of the second fluid line can thus be protected; the curved element forms a housing for the latter. Furthermore, the fluid line can easily be guided to the tool head.

In one embodiment, the tool drive shaft is connected to a flexible drive shaft, which is driven by the drive motor. By means of a flexible shaft, the torque of the drive motor can easily be transmitted from the holding device to a pivotable tool head.

It may be provided that one or more connection elements for a holding belt device are held on the holding device. The cleaning/polishing machine can be supported on the body of the operator by means of the holding belt device, so the exertion of force for holding the cleaning/polishing machine is reduced. The holding belt device can easily be fixed to the holding device for the provision of one or more connection elements.

It is favourable if a minimum length of the holding device is in the range of between 0.50 m and 2.5 m. The corresponding cleaning/polishing machine is then configured as a long-neck machine. A lance mechanism can be produced in which the spacing between the operator and the treatment face can be kept greater than 0.50 m, for example.

In one embodiment, there is arranged on the holding device a receiver, for example in the form of a receiving box with a receiving space for the second fluid line (and optionally a coupling, which is arranged on the second fluid line), if this is not connected with the coupling on the holding device. If the second fluid line is not required, it can optionally be mounted with the corresponding coupling in the receiving space of the receiver and can also be protected thereby or the second fluid line is prevented from hanging loose aid disturbing a treatment process.

It is favourable if a fluid container is arranged on the receiver. This allows the hand-held cleaning/polishing machine according to the invention to be produced in a simple manner and an optimal use of space for the components of the machine is produced.

In one embodiment, a fluid container is provided, which can be carried by an operator and can be connected fluidically to the coupling of the holding device. Such a fluid container is carried, for example, in the manner of a rucksack by the operator. A larger fluid volume can thus be provided. In this case, for example, it is basically also possible for both a fluid container, which is held on the holding device, and also the fluid container carried by the operator, to be coupled to the coupling of the holding device by means of a double coupling.

It may also be provided that a fixing device for a holding strap or holding belt is arranged on the holding device. The fixing device, for example, has a holding eye for the holding strap or holding belt. It is thus possible in a simple manner to fix the holding strap or holding belt on the holding device. In some circumstances, operability is facilitated for the operator if he can hold the machine, for example, by means of a shoulder belt as a holding belt.

The following description of preferred embodiments is used in conjunction with the drawings for a more detailed description of the invention.

### BRIEF DESCRIPTION OF THE DRAWINGS

FIG. 1 shows a perspective view of an embodiment of a cleaning/polishing machine according to the invention;

FIG. 2 shows a sectional view of the cleaning/polishing machine according to FIG. 1 and a variant thereof;

FIG. 3 shows an enlarged view of the region A according to FIG. 1;

FIG. 4 shows a perspective view of a tool head of the cleaning/polishing machine according to FIG. 1 (Region A); and

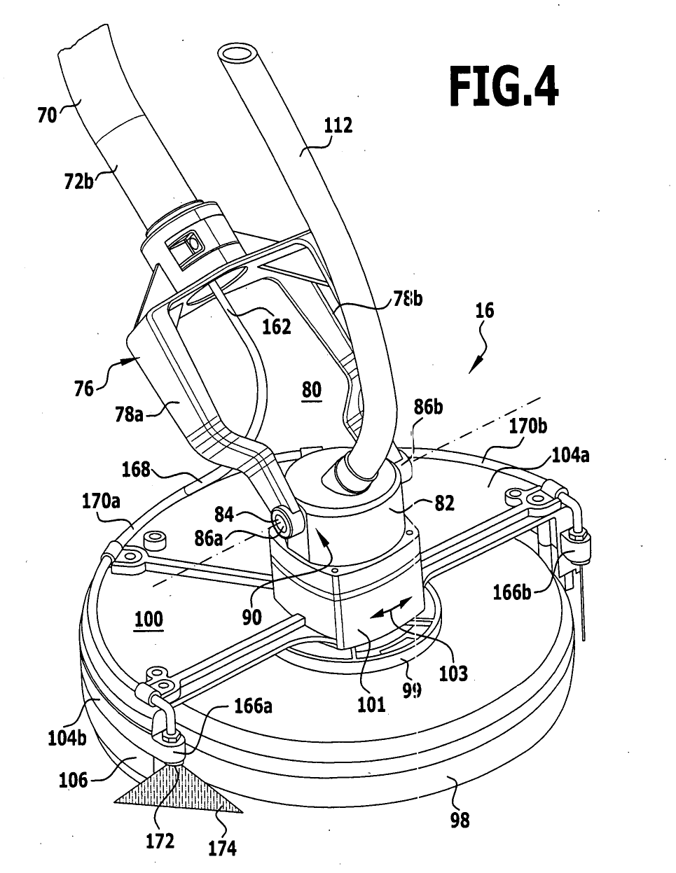

FIG. 5 shows a perspective view of a further embodiment of a cleaning/polishing machine according to the invention.

### DETAILED DESCRIPTION OF THE INVENTION

The mechanism according to the invention is a cleaning/polishing machine. The mechanism may be configured as purely a cleaning machine or as purely a polishing machine. It is also possible for the mechanism according to the invention to be usable both as a cleaning machine and also as a polishing machine.

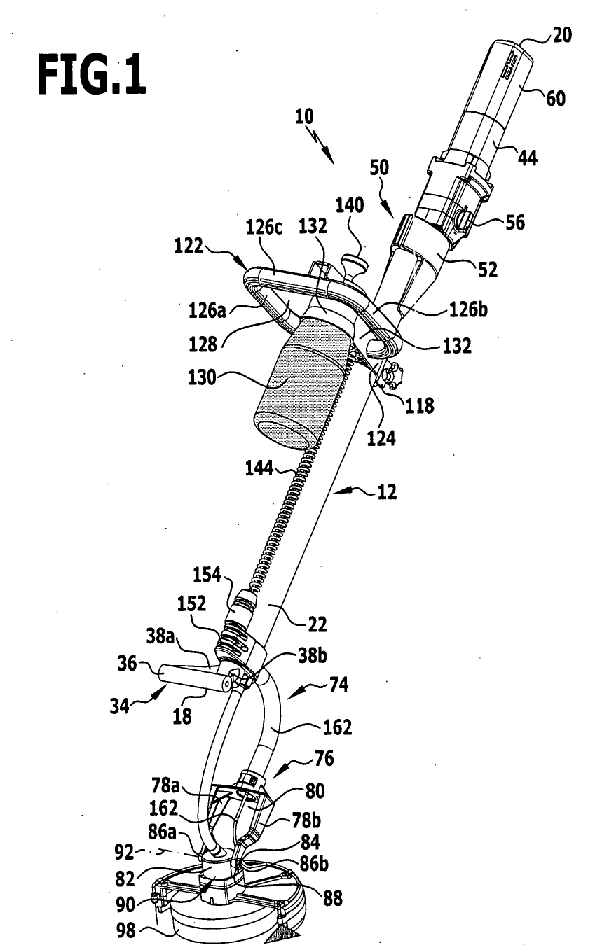

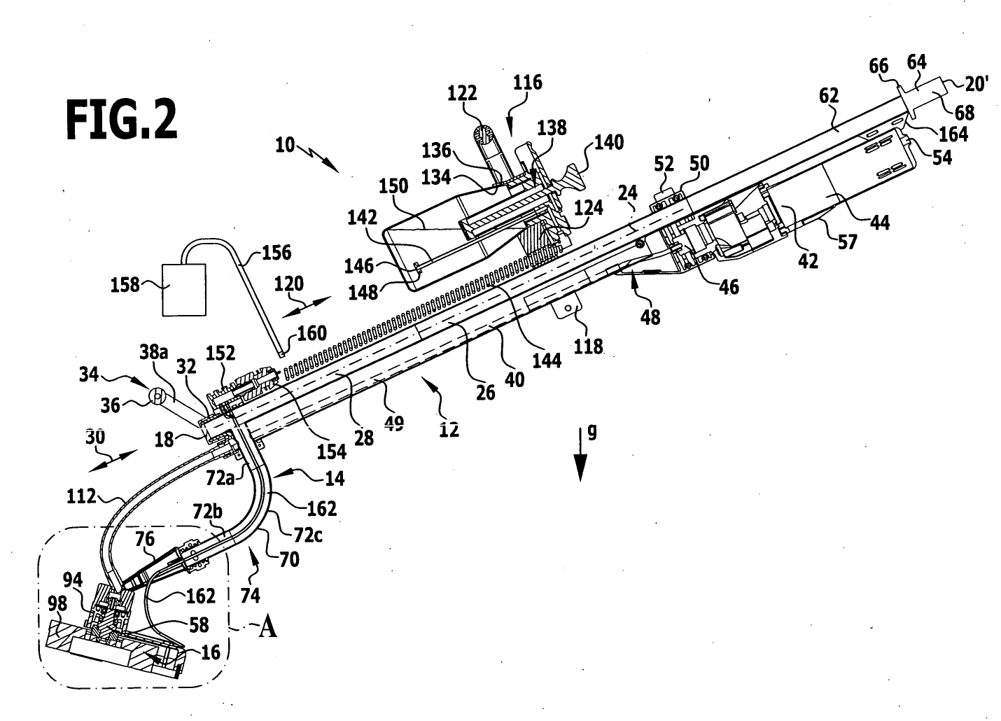

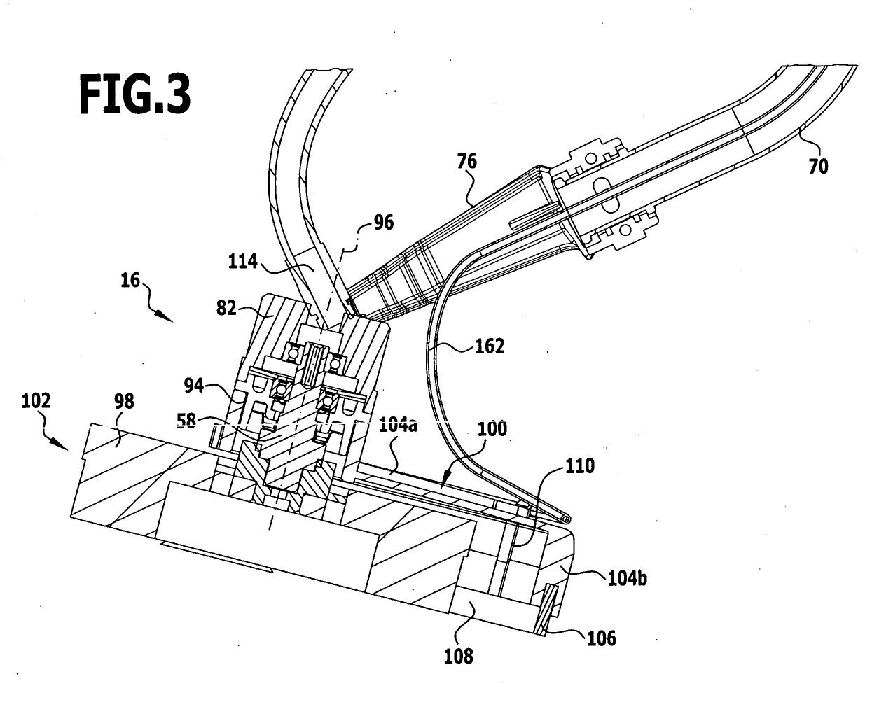

An embodiment of a cleaning/polishing machine according to the invention, which is shown in FIGS. 1 to 3 and designated 10 there, a variant also being shown in FIG. 2, comprises a holding device 12 for the cleaning/polishing machine. An operator can hold the cleaning/polishing machine 10 by means of the holding device and carry out a treatment process such as a cleaning process or polishing process. A tool head 16 is held on the holding device 12 by means of a fixing device 14. A tool, such as a cleaning tool (for example a cleaning brush) or a polishing tool, such as, for example, a polishing disc or buffing disc, can be fixed to the tool head 16.

The cleaning/polishing machine 10 according to the invention is configured, in particular, as a long-neck machine. For this purpose, the holding device 12 has a minimum length between a first end 18 and a second end 20 (FIG. 1) or 20′ (FIG. 2), which lies in the range between 0.50 m and 2.5 m. An operator of the cleaning/polishing machine 10 can thus position himself at a corresponding spacing from the treatment surface. A comfortable cleaning process on a floor surface is thus possible, for example. Furthermore, it is also possible to reach regions on walls which are located higher up.

The holding device 12 comprises a first element 22. This element 22 extends in a longitudinal direction 24. It is configured in the form of a rod. It has a typical length greater than or equal to 0.5 m. An outer face of the first element 22 is preferably edge-free. For example, the first element 22 is oval in shape with respect to its external cross-section.

The first element 22 has a first receiving space 26, in which a rod 28 can be displaced longitudinally in a direction 30 parallel to the longitudinal direction 24. The first receiving space 26 is (hollow) cylindrical, in particular, and the rod 28 has a cylindrical outer face adapted thereto. The rod 28 forms a second element, which is guided on the first element 22.

The rod 28 can be fixed in an infinitely-variable manner in particular, in a displacement position, on the first element 22, for example by means of a clamping device 32.

A handle 34 is seated at one end of the rod 28. This handle 34 is configured as a bow-shaped handle with a cylindrical holding element 36, for example, which is fixed to the rod 28 by means of spaced webs 38, 38b. The holding element 36 is oriented transverse and in particular perpendicular to the direction 30. An operator grips the holding element 36 with one hard, the hand being oriented at least approximately parallel to the longitudinal direction 24.

The rod 28 or the handle 34 defines the first end 18 of the holding device 12. The total length of the holding device 12 can be variably adjusted with respect to the first element 22 by means of the position of the rod 28. An operator can adapt the length of the holding device 12 by means of the rod 28 with the handle 34 to the special treatment process.

The first element 22 has a further receiving space 40 (FIG. 2), in which a part of a transmission device is guided to transmit the torque of a drive motor 42 to the tool head 16 and is arranged in a protected manner. The second receiving space 40 is separated from the first receiving space 26.

It is basically possible for the second receiving space 40 to be arranged in an element separated from the first element 22, this element then being fixed on the first element 22. In the embodiment shown, the first receiving space 26 and the second receiving space 40 are arranged in the same element, namely the first element 22.

The drive motor 42 is fixed on the first element 22 of the holding device 12. The drive motor 42 is in this case arranged in a motor housing 44. The drive motor 42 has a motor shaft 46, which is connected to a transmission device designated 48 as a whole. The transmission device 48 comprises, in particular, a shaft 49. The motor shaft 46 and/or a part of the transmission device 48 (in particular the shaft 49) are arranged in the second receiving space 40. The torque of the drive motor 42 can thus be transmitted through the holding device 12 to the tool head 16. In particular, a shaft is rotatably mounted in the second receiving space 40, by means of which shaft the torque of the drive motor 42 can be transmitted through the second receiving space 40.

The drive motor 42 is fixed by means of its motor housing 44 with a fixing device 50 on the holding device 12 and, in particular, the first element 22 of the holding device 12. The fixing device 50 comprises, for example, a clamping holder 52, which is fixed in a clamping manner on the first element 22. The clamping holder in turn holds the motor housing 44 with the drive motor 42. The clamping holder 52 is arranged and configured in such a way that the drive motor 42 is seated below an extension of the first element 22 in the longitudinal direction 24.

The drive motor 42 is, in particular, an electric motor, which can be supplied with electrical power by a network current. (In FIG. 2, a cable connection is indicated by the reference numeral 54). A switch 56 for adjusting the rotational speed of the drive motor 42 is arranged on the motor housing 44. This switch 52 is arranged laterally, in particular. The drive motor 42, for example, has two different rotational speeds (gears).

An on/off switch 57, by means of which the operation of the drive motor 42 can be switched on or off, is arranged on the lower side of the motor housing 44.

It is basically also possible for the drive motor to be a storage battery-operated electric motor. Furthermore, it is basically also possible for the drive motor, for example, to be a combustion motor or a pneumatic or hydraulic drive motor.

In one embodiment it is provided that the drive motor 42 has a variable rotational speed, so that, depending on the application, the suitable rotational gear can be adjusted. It is provided, for example, that the drive motor 42 has a first rotational gear for a cleaning treatment and a second rotational gear for a polishing treatment. The required rotational for polishing treatment processes is generally higher than for cleaning processes. For example, the drive motor 42 is configured in such a way that a polishing tool can be operated at rotational speeds greater than 2,000 revolutions per minute and a cleaning tool at rotational speeds of less than 2,000 revolutions per minute. In a specific embodiment, the drive motor 42 is configured in such a way that a polishing tool and be operated at a rotational speed in the order of magnitude of 3,000 revolutions per minute and a cleaning tool can be operated at a rotational speed in an order of magnitude of 1,000 revolutions per minute.

The rotational speed of the motor shaft 46 does not have to coincide here with the rotational speed of a drive shaft 58 of the tool head 16. A rotational gear reduction, in particular, may take place from the drive motor 42 to the tool drive shaft 58 owing to the transmission device 48.

In the embodiment shown in FIG. 1, the second end 20 of the holding device 12 is determined by an end of the motor housing 44. The motor housing 44 forms a handle 60, by means of which an operator can hold the cleaning/polishing machine 10. An operator can take hold of the motor housing 40 with one hand. The hand, in this case, is oriented with the fingers transverse to the longitudinal direction 24. In this example, the first element ends on the clamping holder 52.

In a further embodiment, which is shown in FIG. 2, a rod 62 is arranged on the first element 22 in the region of the clamping holder 52, on which rod a further handle 64 is seated. The rod 62 is located above the motor housing 44, substantially parallel thereto, and projects beyond the motor housing 44. The handle 64 thus also projects beyond the motor housing 44. The handle 64, in this case, has a hand plate 66 and a holding element 68. The holding element 68 is cylindrical, in this case, for example, so the handle 64 is a cylindrical handle. An operator can grip the handle 64 with one with, the fingers, during the gripping, lying substantially transverse to the longitudinal direction 24.

It may be provided that the rod 62 with the handle 64 can be removed from the first element 22. It is also possible for the rod 62 to be fixedly arranged on the first element 22. It is furthermore possible for the rod 62 to be fixedly and in particular integrally connected to the first element 22.

It is furthermore possible for the rod 62 to be displaceably arranged on the first element 22, and in particular to be partly inserted in the first receiving space 26.

The length of the holding device between the first end 18 and its second end 20 or 20′ is determined by the position of the handle 34 relative to the first element 22. If the position of the handle 64 relative to the first element 22 is variable, the length of the holding device 12 in the longitudinal direction 24 is also determined by how the handle 64 is positioned relative to the first element 22.

It is basically also possible for the drive motor 42 to not be seated on the holding device 12, but be held separately, for example, by an operator. For example, an operator holds the drive motor with a holding belt. The transmission device from the drive motor then has to be correspondingly configured.

A curved element 70 is arranged on or close to the end of the rod 28, which is adjacent to the tool head 16. This curved element has a first region 72a, in which it extends transversely and in particular perpendicularly to the longitudinal direction 24 away from the first element 22. It has a second region 72b, in which it extends substantially parallel to the longitudinal direction 24 of the first element. A transition region 72c is arranged between the first region 72a and the second region 72b. The curved element 70, with the second region 72b, projects over the end of the rod 28.

The curved element 70 is rigidly arranged on the holding device 12.

The tool head 16 is seated so as to be pivotable about at least one axis on the curved element 70 and can therefore be pivoted about this at least one axis relative to the holding device 12. A fixing device 74 for a pivotable hold of the tool head 16 on the holding device 12 is formed by means of the curved element 70.

The fixing device 74 comprises a holding fork member 76 with a first web element 78a and second web element 78b. The two web elements 78a and 78b are spaced apart from one another with an intermediate space 80 between them.

The tool head 16 has a holding region 82, which is cylindrical, for example. Arranged on this holding region 82 is a shaft 84, which projects on either side beyond the holding region 82. The shaft 84, which can be implemented by means of one or two pin elements, is, in particular, rigidly arranged on the holding region 82. The web elements 78a and 78b have corresponding openings 86a, 86b adapted to the shaft 84, in which openings the shaft 84 is inserted. The path movement of the web elements 78a, 78b to the outside from the holding region 82 is blocked by means of corresponding securing elements 88 seated on the shaft 84. (The inward movement to the holding region 82 is blocked by the holding region 82 itself.) A pivot bearing 90, which has a pivot axis 92 is thus formed by means of the shaft 84 and the web elements 78a, 78b with their openings 86a, 86b. The pivot axis 92 is, in this case, oriented transversely and in particular perpendicularly to the longitudinal direction 24 and to the displacement direction 30.

The position of the tool head with respect to the holding device 12 can be adapted by the pivotability of the tool head 16 about the pivot axis 92. For example, the angle of the holding device 12 can be adapted to the floor during a floor treatment. When treating a wall, the angle with respect to the wall and therefore also the spacing of an operator with respect to the wall can be adapted.

The tool head 16 comprises a bearing device 94 for the tool drive shaft 58, in which the latter is rotatably mounted about a rotational axis 96. The tool drive shaft 58 is arranged so as to be protected in the bearing device 94, which is configured in the shape of a housing. The holding region 82 is seated on the bearing device 94.

A tool 98 (such as for example a cleaning tool or polishing tool) can be connected to the tool drive shaft 58 so as to be resistant to rotation. The tool head 16, for example, has a bayonet closure 99, so as to be able to fix a corresponding tool 98.

Seated on the bearing device 54 is a protective hood 100, which partly covers the tool 98 toward the top and the side. The protective hood 100 extends in an angular range (in relation to the rotational axis 96) which is less than 360°. In the embodiment shown, the protective hood 100 extends at an angular range of about 180°. The tool 98 thus exits from the protective hood in a front region 102, for example. Thus, it is possible to treat corners or edges, for example.

The protective hood 100 can be rotatably fixed to the tool head 16 by a corresponding bearing device 101. A rotational position or pivoting position of the protective hood 100 relative to the holding region 82 can be adjusted, in particular. A corresponding rotational axis/pivot axis is thus at least approximately parallel to the rotational axis 96 at the tool 98. A corresponding capacity of the protective hood 100 to rotate or pivot is indicated in FIG. 1 by the double arrow with the reference numeral 103. By means of the capacity of the protective hood 100 to rotate or pivot, how the front region 102 is located with respect to the holding device 12 can be adjusted.

The protective hood 100 has an upper region 104a and a side region 104b. The upper region 104a is oriented with a surface normal substantially parallel to the rotational axis 96. The side region 104b is oriented with a side wall substantially parallel to the rotational axis 96 or with a normal transverse and, in particular thereto.

It may be provided that a lip 106, for example made of a rubber material or in the form of a brush ring is arranged on the side region 104b and can be placed on a treatment surface and ensures a fluid seal between the treatment area and the protective hood 100.

A free space 108 is formed between the tool 98 and the side region 104b.

The curved element 70 is arranged directed downwardly on the holding device 12. It is directed to the same side as the drive motor 42.

A curved protective housing 112, in which a flexible drive shaft 114 is guided, is arranged between the first element 22 and, in particular, between the second receiving space 40 of the first element 22 and the tool head 16. The drive shaft 14 is non-rotatably connected to the tool drive shaft 58. It is furthermore part of the transmission device 48. It is connected non-rotatably directly or by means of one or more intermediate shafts to the drive motor 42. The protective housing 112 and the drive shaft 114 are configured in such a way that in any allowed pivoting position of the tool head 16 relative to the housing device 12, a torque transmission to the tool drive shaft 58 (and therefore to the tool 98) is ensured.

The protective housing 112 is connected to the first element 22, in particular in the region of the curved element 70. The connection is thus arranged below the first receiving space 26, so the displaceability of the rod 28 is not impeded.

A fixing device 116, which can be displaced so as to be lockable on the first element 22, is arranged on the first element 22. The fixing device 116, for example, comprises a clamping holder 118 which is displaceable in a direction 120. The direction 120 is parallel, in this case, to the longitudinal direction 24 and the direction 30. By clamping the clamping holder 118, the fixing device 116 can be locked against displacement on the first element 22.

The fixing device 116 carries a further handle 122, which is configured as a bow. The handle 122 projects beyond the first element 22 at an upper side. The upper side is, in this case, remote from the side, on which the tool head 16 is arranged.

The handle 122, which is bow-shaped, is arranged on a holding element 124 of the fixing device 116. It is annular or rectangular with a first region 126a, a spaced-apart opposing second region 126b and a third region 126c, which connects the first region 126a and the second region 126b spaced apart from the holding element 124. The first region 126a is arranged transversely and in particular perpendicularly to the third region 126c. The second region 126b is arranged substantially parallel to the first region 126b. A free space 128 is formed between the regions toward the holding element 124. An operator can selectively grasp the handle 122 on the first region 126a, the second region 126b or the third region 126c.

It is also possible, for example, for an operator to hold the handle 122 on the first region 126a with one hand and on the second region 126b with the other hand.

The third region 126c is oriented transversely and, in particular, perpendicularly to the longitudinal direction 24. If an operator holds the handle 122 at the third region 126c, his hand is oriented substantially parallel to the longitudinal direction 24.

Arranged on the fixing region 116 and in particular the holding element 124 in the free space 128 is (at least) one fluid container 130. The fluid container 130 can receive a fluid such as water or a cleaning fluid. The fluid container 130 can be removed from the fixing device 116.

A fluid container holder 132 is fixedly arranged for this purpose on the fixing device 116. The fluid container holder 132 is, in particular, fixedly arranged on the holding element 124. The fluid container holder 132 comprises an internal thread 134, in which the fluid container 130 is screwed with a corresponding external thread 136.

A hand pump 138 with a pump handle 140 is arranged in the fluid container holder 132. The pressure under which fluid is held in the fluid container 130, can be manually increased by means of the hand pump 138.

A suction line 142, by means of which fluid can be sucked from the fluid container 130, is arranged in the fluid container 130. A fluid line 144, which is in fluidic connection with the suction line 142, is also connected to the fluid container 130. Fluid from the fluid container 130, which is sucked in by the suction line 142, can be removed through the fluid line 144.

The suction line 142 is produced from a flexible material. A weight element 146, for example made of metal, is arranged at its lower end. The flexible configuration of the suction line 142 and the weight element 146 ensures that an inlet 148 of the suction line 142 lies in a lower region of the fluid container 130 in relation to the direction of gravitational force. This makes the sucking in of fluid from the fluid container 130 possible in relation to the direction of gravitational force for all positions of the cleaning/polishing machine 10. In particular, an overhead wet treatment is possible.

A fluid level 150 is shown schematically in FIG. 2 when the holding device 12 is orientated with its longitudinal direction 24 inclined to the direction of gravitational force g. The flexible configuration of the suction line 142 ensures that the inlet 148 for each angular position is below the fluid level 150 (in FIG. 2, the suction line 142 is shown straight for viewing reasons; this position is adopted if the longitudinal direction 24 is parallel to the direction of gravitational force g and therefore the fluid level 150 is perpendicular to the direction of gravitational force g. In the position shown in FIG. 2 of the cleaning/polishing machine 10 with respect to the direction of gravitational force g, the suction line 142 with its weight element 146 is displaced downwardly in comparison to the position drawn.)

At least one coupling 152 is arranged on the holding device 12 on the first element 22 close to a lower end of the first element 22. A coupling 154 is also arranged on one end of the fluid line 144 (FIG. 1). The couplings 152 and 154 are standard couplings, in particular. The fluid line 144 can be connected fluidically to the coupling 152 by means of the coupling 154. Thus, fluid can be guided from the fluid container 130 to the coupling 152.

The fluid line 144 is configured, in particular, as a spiral line. The spacing between the coupling 152 and the fixing device 116 depends on the position of the fixing device 116 (on the position of the clamping holder 118) at the first element 22. The spacing of the fluid container 130 with respect to the coupling 152 is thus also variable. The configuration as a spiral line means that a connection of the fluid line 144 to the coupling 152 is possible in any position of the fluid container 130.

The fluid line 144 is a first fluid line, which can be connected to the coupling 152.

An external fluid line 156, as the first fluid line, can also selectively be connected to the coupling 152 (FIG. 2). In particular, the external fluid line 156 is a fluid hose, which is connected to a fluid tank 158 or connected to another water source, such as, for example, a water tap. The external fluid line 156 correspondingly has a coupling 160, which can be connected to the coupling 152.

The fluid line 144 is guided above the holding device 12 (above the first element 22). In particular, the fluid line 144 is free, i.e. it is only connected to the fluid container 130 and not otherwise fixed to the holding device 12.

From the coupling 152, a second fluid line 162 leads through the holding device 12 on the first element 22 (and thus past the first receiving space 26) through an interior space of the curved element 70 and through the intermediate space 80 on the holding fork member 76 to the fluid line 110. Fluid can thus be selectively provided to the tool 98 by means of the fluid hose 158 or by means of the fluid container 130. The cleaning action or polishing action can be improved by means of the fluid provided, which may be water or another cleaning fluid (possibly with a cleaning additive). The lip 106 is used to increase the “residence duration” of the fluid at the tool 98, in that a backward flowing off of fluid is reduced.

It is basically also possible that, instead of a single coupling 152, a plurality of couplings and, in particular, a first and a second coupling are arranged (not shown in the drawing). The external fluid line 156 can be connected by means of a coupling in order to provide water, for example. The fluid line 144 can be connected by means of the other coupling to provide fluid and in particular cleaning fluid from the fluid container 130. A mixing of the water and cleaning fluid may then take place in the region of the couplings, and a cleaning fluid/water mixture may be supplied to the tool 98 in this embodiment.

The fluid line 162 provides fluid to nozzles 166a, 166b. The nozzles 166a, 166b are arranged on the end face on the side region 104b on the protective hood 100. In the embodiment shown, two opposing nozzles 166a, 166b are provided. More than two nozzles may also be provided.

A branch 168, from which a first fluid line 170a leads to the nozzle 166a, and from which a second fluid line 170b leads to the nozzle 166b, is seated on the fluid line 162. The fluid lines 170a and 170b are fixed on the upper region 104a of the protective hood 100. The fluid line 162, the branch 168 and optionally the fluid lines 170a, 170b are arranged and configured such that if a rotatability of the protective hood 100 on the bearing device 101 is provided (for example about an angle of ±35°), the fluid supply to the nozzles 166a, 166b is ensured in any allowed rotational position. In particular, the second fluid line 162 and optionally the first fluid line 170a and the second fluid line 170b are flexible.

The nozzles 166a, 166b in each case have a nozzle opening 172, which is directly downwardly (away from the upper region 104a of the protective hood 100).

The nozzle openings 102 are configured, in particular in such a way that a corresponding fluid jet 174 which exits from them, has a relatively small width and, for example, is triangular. It is in particular ensured that the fluid jet 174 does not spray the tool 98 directly, but arrives directly on the treatment face, on which the tool 98 is placed.

The cleaning/polishing machine according to the invention functions as follows:

The handle 122 forms a first handle. The handle 34 forms a second handle. The handle 60 or 64 forms a third handle. It is basically possible, in this case, that the second handle 34 is not present.

An operator can grasp the cleaning/polishing machine 10 on these handles. Depending on the treatment process, he can select the optimised handle position. He can furthermore adjust the handle 34 in relation to the first element 22 and the handle 122 to the first element 22 so as to be adapted to the special treatment process. Owing to this adjustability by means of a displacement in the direction 30 or the direction 122, the relative position of the handles 34 and 120 in relation to the tool head 16 can also be adjusted.

The operator can selectively supply fluid from the fluid container 130 or the external fluid line 156 to the tool 98, in that he connects the external fluid line 156 or the external fluid line 144 to the coupling 152. Depending on the treatment process and the local conditions, the fluid supply to the tool 98 can be selected.

The operator can adjust the necessary rotational speed for the rotation of the tool 98 about the rotational axis 96 adjusting the rotational speed of the drive motor 42. For example, in a cleaning process, a low rotational speed in the order of magnitude of 1,000 revolutions per minute is selected and for a polishing process, a higher rotational speed in the order or magnitude of 3,000 revolutions per minute is selected.

For a surface treatment (cleaning or polishing) the tool 98 is placed on the treatment surface. The operator positions himself according to whether the treatment surface is a floor surface, wall surface or ceiling surface. Simplified treatment is possible owing to the pivotable mounting of the tool head 16.

Fluid is sprayed onto the treatment surface by means of nozzles 166a, 166b.

The flexible suction line 142 and the fluid container 130 ensure that if fluid is supplied from the fluid container 130, it is possible to suck in fluid in any position of the cleaning/polishing machine.

Sucking in can be facilitated in a simple manner by the provision of the hand pump 138. In this case, an operator removes the fluid container 130, fills it with fluid (in particular water) and fixes it on the fluid container holder 132 again. A corresponding pressure is produced by the hand pump 138, which is sufficient to convey the fluid to the tool 98. Prior to the treatment, a switch or valve is opened, which allows the fluid to flow through to the fluid line 144.

It may be provided that one or more connection elements 164 for a holding belt are arranged on the holding device. For example a connection element of this type is arranged on the rod 62. A holding belt can be suspended on the connection element 164. Thus, the cleaning/polishing machine 10 can be supported in the region of this connection element 164 to facilitate treatment of a treatment surface for the operator.

Connection elements 164 may also be provided at other locations of the holding device 12.

The second handle 34 is optional. The designation of the handle 122 as the first handle, the handle 60 or 64 as the second handle and of the handle 34 as the third handle does not mean that three handles have to be present. It is, for example, possible for only one handle or two handles to be present.

It may be provided that the motor housing 44 is removably arranged on the holding device 12. In this case, it may basically be provided that a treatment tool can be fixed directly on the removed motor housing 44. This allows the drive motor 42 to be used directly for treatment processes. For example, polishing in corners or edges is thus possible.

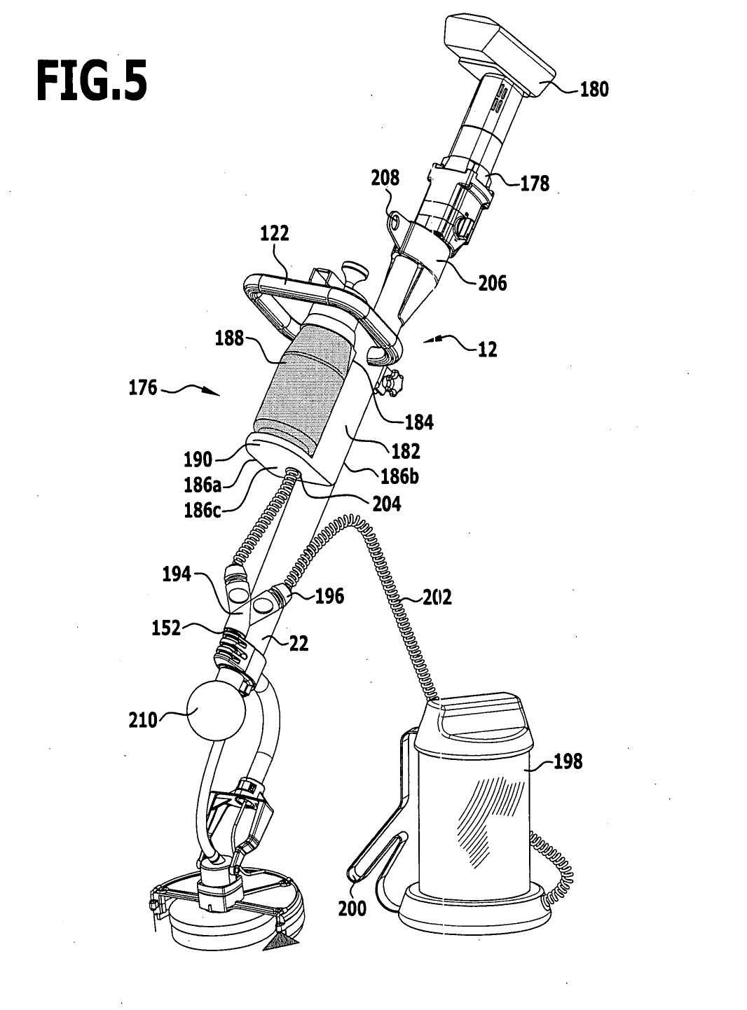

A further embodiment of a hand-held cleaning/polishing machine according to the invention, which is shown in FIG. 5 and designated 176, is basically configured the same as the cleaning/polishing machine 10. The same reference numerals are used for the same elements. A drive motor 178, which can be operated by a storage battery, is held on the holding device 12 of the cleaning/polishing machine 176. For this purpose, a storage battery 180 can be coupled to the drive motor 178.

A receiver 182 in the form of a receiving box is arranged in the region of the handle 122 on the first element 22 of the holding device 12. The receiver 182 has an inner receiving space 184, which is limited by opposing walls 186a, 186b and an end wall 186c. The receiving space 184 is limited toward an upper side by a fluid container 188, which corresponds to the fluid container 130. The end wall 186 has a placement region 190 for the fluid container 188.

From the fluid container 188, a second fluid line 192 leads to the coupling 152 on the holding device 12.

In the embodiment shown, a double coupling 194 with three connection points, namely a connection point for the coupling 152, a further connection point for the second fluid line 192 and a connection point 196 for an “external” fluid container 198, which a user can carry by means of a holding belt 200 on his back, is seated on the coupling 152. A fluid line 202 is fluidically connected to the fluid container 198 and attached to the double coupling 194 at the connection point 196.

The second fluid line 192 can be displaced into the receiving space 184, if it is not connected to the coupling 152. For this purpose, arranged on the end wall 186c is an opening 204, through which the second Fluid line 192 is guided. The latter can be displaced into the receiving space 184 through the opening 204. Optionally, a coupling arranged on the second fluid line 192 may also be displaced into the receiving space 184. The second fluid line 192 may preferably be stowed completely in the receiving space 184 and a coupling which is on the second fluid line 192, can optionally be stowed therein.

A fixing device 206 for a holding belt for holding the cleaning/polishing machine 176 is arranged on the holding device 12 between the drive motor 178 and the handle 122. This fixing device 206 in particular comprises a holding eye 208 for engagement of the holding belt.

A handle 210, which is configured as a spherical handle and at least approximately has a spherical shape, is arranged at a lower end of the first element 22. It can be grasped from almost all directions by the hand, so simple operability of the cleaning/polishing machine 176 is possible.

Otherwise, the cleaning/polishing machine 176 operates as described above.

1. Hand-held cleaning/polishing machine, comprising:
a holding device for holding the cleaning/polishing machine;
a drive motor;
a tool head for one or more cleaning tools and/or polishing tools, which has a tool drive shaft driven by the drive motor;
a transmission device for transmitting torque from the drive motor to the tool drive shaft; and
at least one coupling for connecting at least one first fluid line, said at least one coupling being arranged on the holding device and at least one second fluid line leading to the tool head from the at least one coupling.

2. Hand-held cleaning/polishing machine according to claim 1, wherein a fluid container is arranged on the holding device.

3. Hand-held cleaning/polishing machine according to claim 2, wherein a fluid line, which is connectable to the at least one coupling, is connected to the fluid container.

4. Hand-held cleaning/polishing machine according to claim 3, wherein at least one of an external hose and the fluid line connected to the fluid container is selectively fluidically connectable to the second fluid line by the at least one coupling.

5. Hand-held cleaning/polishing machine according to claim 2, wherein the fluid container is configured as a pressure container.

6. Hand-held cleaning/polishing machine according to claim 2, wherein a pump is arranged on the fluid container.

7. Hand-held cleaning/polishing machine according to claim 6, wherein the pump is a hand pump.

8. Hand-held cleaning/polishing machine according to claim 2, wherein the fluid container or a part of the fluid container is removably fixed to the holding device.

9. Hand-held cleaning/polishing machine according to claim 2, wherein a suction line is arranged in the fluid container and is fluidically connected to the fluid line connected to the fluid container.

10. Hand-held cleaning/polishing machine according to claim 9, wherein the suction line is flexible.

11. Hand-held cleaning/polishing machine according to claim 9, wherein a weight element is arranged on or close to an inlet of the suction line.

12. Hand-held cleaning/polishing machine according to claim 1, wherein a handle is arranged on the holding device between an end adjacent to the tool head and an end remote from the tool head.

13. Hand-held cleaning/polishing machine according to claim 12, wherein the handle is configured as a bow-shaped handle.

14. Hand-held cleaning/polishing machine according to claim 12, wherein a position of the handle on the holding device is variably adjustable.

15. Hand-held cleaning/polishing machine according to claim 12, wherein the handle is arranged on a fixing device.

16. Hand-held cleaning/polishing machine according to claim 15, wherein the fixing device is displaceably positionable on the holding device so as to be lockable.

17. Hand-held cleaning/polishing machine according to claim 16, wherein a spacing of the handle from the at least one coupling is adjustable.

18. Hand-held cleaning/polishing machine according to claim 16, wherein a spacing of the handle from a fixing device of the tool head on the holding device is adjustable.

19. Hand-held cleaning/polishing machine according to claim 16, wherein a fluid container is arranged on the fixing device of the handle.

20. Hand-held cleaning/polishing machine according to claim 19, wherein the fluid container with the fixing device of the handle is displaceably positionable on the holding device so as to be lockable.

21. Hand-held cleaning/polishing machine according to claim 19, wherein a spacing of the fluid container from the at least one coupling is variable.

22. Hand-held cleaning/polishing machine according to claim 15, wherein the fixing device of the handle comprises a clamping holder for fixing on the holding device.

23. Hand-held cleaning/polishing machine according to claim 12, wherein the handle is positioned between the drive motor and the at least one coupling.

24. Hand-held cleaning/polishing machine according to claim 1, characterised by a handle, which is arranged on or close to an end of the holding device, which is adjacent to the tool head.

25. Hand-held cleaning/polishing machine according to claim 24, wherein the handle is configured as a bow-shaped handle or spherical handle.

26. Hand-held cleaning/polishing machine according to claim 24, wherein a spacing of the handle from the at least one coupling can be adjusted.

27. Hand-held cleaning/polishing machine according to claim 24, wherein a spacing of the handle relative to a fixing device of the tool head on the holding device can be adjusted.

28. Hand-held cleaning/polishing machine according to claim 24, wherein the at least one coupling is positioned between the handle and a further handle, which is arranged on the holding device.

29. Hand-held cleaning/polishing machine according to claim 24, wherein the handle is held on a second element of the holding device, which is at least partly inserted in a receiving space of a first element of the holding device.

30. Hand-held cleaning/polishing machine according to claim 29, wherein the second element is a rod.

31. Hand-held cleaning/polishing machine according to claim 29, wherein the first element is a tube.

32. Hand-held cleaning/polishing machine according to claim 29, wherein the at least one coupling is arranged on the first element.

33. Hand-held cleaning/polishing machine according to claim 1, characterised by a handle, which is arranged on or close to an end of the cleaning/polishing machine remote from the tool head.

34. Hand-held cleaning/polishing machine according to claim 33, wherein the handle has a hand plate.

35. Hand-held cleaning/polishing machine according to claim 33, wherein the handle is configured as a cylindrical handle.

36. Hand-held cleaning/polishing machine according to claim 33, wherein the handle projects beyond the drive motor.

37. Hand-held cleaning/polishing machine according to claim 33, wherein the handle is formed on a motor housing of the drive motor.

38. Hand-held cleaning/polishing machine according to claim 33, wherein the handle is removable.

39. Hand-held cleaning/polishing machine according claim 1, wherein the drive motor is arranged on the holding device.

40. Hand-held cleaning/polishing machine according to claim 39, wherein the drive motor is removable.

41. Hand-held cleaning/polishing machine according to claim 39, wherein the drive motor is arranged on the holding device on or close to an end remote from the tool head.

42. Hand-held cleaning/polishing machine according to claim 1, wherein the drive motor has an adjustable rotational speed.

43. Hand-held cleaning/polishing machine according to claim 42, wherein the drive motor has at least a first rotational gear for cleaning processes and a second rotational gear for polishing processes.

44. Hand-held cleaning/polishing machine according to claim 43, wherein a rotational tool speed for the first rotational clear is below 2,000 rpm.

45. Hand-held cleaning/polishing machine according to claim 43, wherein a rotational tool speed for the second rotational gear is above 2,000 rpm.

46. Hand-held cleaning/polishing machine according to claim 1, wherein the tool head with a fixing device is arranged on the holding device so as to be pivotable about at least one pivot axis.

47. Hand-held cleaning/polishing machine according to claim 46, wherein the at least one pivot axis is oriented transversely to a longitudinal direction of the holding device.

48. Hand-held cleaning/polishing machine according to claim 46, wherein the fixing device for the tool head comprises a holding fork member.

49. Hand-held cleaning/polishing machine according to claim 46, wherein the fixing device for the tool head comprises a curved element, which is positioned on the holding device.

50. Hand-held cleaning/polishing machine according to claim 49, wherein the second fluid line is at least partly guided in the curved element.

51. Hand-held cleaning/polishing machine according to claim 1, wherein the tool drive shaft is connected to a flexible drive shaft, which is driven by the drive motor.

52. Hand-held cleaning/polishing machine according to claim 1, wherein one or more connection elements for a holding belt device are arranged on the holding device.

53. Hand-held cleaning/polishing machine according to claim 1, wherein a minimum length of the holding device is in the range between 0.50 m and 2.5 m.

54. Hand-held cleaning/polishing machine according to claim 1, wherein there is arranged on the holding device a receiver with a receiving space for the second fluid line when the latter is not connected with the coupling.

55. Hand-held cleaning/polishing machine according to claim 54, wherein a fluid container is arranged on the receiver.

56. Hand-held cleaning/polishing machine according to claim 1, characterised by a fluid container, which is adapted to be carried by an operator and is fluidically connectable to the coupling.

57. Hand-held cleaning/polishing machine according to claim 1, wherein a fixing device for a holding strap or holding belt is arranged on the holding device.
